(19) United States
(12) Patent Application Publication
(10) Pub. No.: US 2023/0307700 A1
(43) Pub. Date: Sep. 28, 2023

(54) SOLID ELECTROLYTE SHEET AND SOLID-STATE BATTERY

(71) Applicant: HONDA MOTOR CO., LTD., Tokyo (JP)

(72) Inventors: Yohei NOJI, Saitama (JP); Akihiro YOSHIZAWA, Saitama (JP)

(21) Appl. No.: 18/191,892

(22) Filed: Mar. 29, 2023

(30) Foreign Application Priority Data
Mar. 22, 2022 (JP) 2022-060538

(51) Int. Cl. H01M 10/0562; H01M 4/38; H01M 4/40

(52) U.S. Cl. CPC H01M 10/0562; H01M 4/386; H01M 4/405; H01M 2300/0068

(57) ABSTRACT

To provide a solid electrolyte sheet with high strength that allows for a thinner sheet, and a solid-state battery provided with such a solid electrolyte sheet. A solid electrolyte sheet 31 is provided with a porous base material 33, a solid electrolyte material filling voids in the base material 33, and a binder adhering to the base material 33, wherein when 100% by mass is taken to mean an entirety of the solid electrolyte sheet 31, content of the binder is equal to or higher than 10% by mass. A solid-state battery 1 is provided with a positive electrode layer 11, a negative electrode layer 21, and a solid electrolyte layer 30 located between the positive electrode layer 11 and the negative electrode layer 21, wherein the solid electrolyte layer includes the solid electrolyte sheet 31.

This application is based on and claims the benefit of priority from Japanese Patent Application No. 2022-060538, filed on Mar. 31, 2022, the content of which is incorporated herein by reference.

### BACKGROUND OF THE INVENTION

### Field of the Invention

The present invention relates to a solid electrolyte sheet and a solid-state battery.

### Related Art

In recent years, secondary batteries that can be charged and discharged repeatedly, as typified by lithium-ion batteries, have come into widespread use. Secondary batteries of this type use an electric field solution such as an organic solvent as the ion transfer medium, and thus are problematic in view of leakage of the electrolytic solution, safety with respect to heat, and the like. Accordingly, solid-state batteries using an inorganic solid electrolyte instead of an organic electrolyte are being proposed and developed.

Ordinarily, a solid-state battery has a structure in which a solid electrolyte layer is interposed between a positive electrode and a negative electrode. The solid electrolyte layer is famed from a solid electrolyte sheet containing a solid electrolyte. For example, a solid electrolyte layer of a lithium-ion solid-state battery functions to conduct lithium ions and functions as a separator that prevents shorting between a positive electrode active material layer in the positive electrode and a negative electrode active material layer in the negative electrode. To improve the energy density, the solid electrolyte sheet forming such a solid electrolyte layer is preferably as thin as possible. However, since simply making the sheet thinner may cause cracks or the like to occur due to reduced strength, a solid-state battery is known in which a base material is included to attain a thinner and reinforced solid electrolyte sheet. Japanese Unexamined Patent Application, Publication No. 2015-153460 discloses a solid electrolyte sheet containing a binder that binds together an electrode active material.
Patent Document 1: Japanese Unexamined Patent Application, Publication No. 2015-153460

### SUMMARY OF THE INVENTION

In the case of including a binder in a solid electrolyte sheet, it is typical to use a binder that inhibits ion conductivity as little as possible. However, if the amount of the binder is too small, insufficient strength will be obtained when foaming the solid electrolyte sheet in a high-pressure press, and there is the possibility of shorting. In view of increasing the size and mass production of solid-state battery cells, pressurization using a roll press is necessary, but a roll press exhibits anisotropic deformation during pressurization compared to an isostatic press, such as an in-mold press or a hydraulic press, which has been used for small cells conventionally. Thus, to press at higher pressures while preventing shorting, higher strength is desired for the solid electrolyte layer. To this end, it is possible to improve the strength using a composite of a base material and a solid electrolyte, but if the amount of binder is too small, cracking and particle shedding will occur during handling, making cell formation difficult. Furthermore, even greater strength is desired in the case of making the solid electrolyte sheet thinner in order to improve the energy density.

The present invention has been devised in light of the above circumstances, and an objective thereof is to provide a solid electrolyte sheet with high strength that allows for a thinner sheet, and a solid-state battery provided with such a solid electrolyte sheet.
(1) A solid electrolyte sheet according to the present invention is a solid electrolyte sheet provided with a porous base material, a solid electrolyte material filling voids in the base material, and a binder adhering to the base material, wherein when 100% by mass is taken to mean an entirety of the solid electrolyte sheet, content of the binder is equal to or higher than 10% by mass.
(2) A solid-state battery according to the present invention is a solid-state battery provided with a positive electrode layer including a positive electrode active material, a negative electrode layer including a negative electrode active material, and a solid electrolyte layer located between the positive electrode layer and the negative electrode layer, wherein the solid electrolyte layer includes the solid electrolyte sheet according to (1), and the negative electrode layer includes, as the negative electrode active material, at least one selected from a Li-based material and a Si-based material.

According to the present invention, it is possible to provide a solid electrolyte sheet with high strength that allows for a thinner sheet, and a solid-state battery provided with such a solid electrolyte sheet.

### BRIEF DESCRIPTION OF THE DRAWINGS

FIG. 1 is a cross section that schematically illustrates a configuration of a solid-state battery according to an embodiment;

FIG. 2 is a perspective view that schematically illustrates a structure of a solid electrolyte layer according to the embodiment;

FIG. 3 is a graph illustrating measurement results of tensile strength in an example and a comparative example;

FIG. 4A is a surface photograph of a solid electrolyte sheet (with cracks) according to a comparative example;

FIG. 4B is a surface photograph of a solid electrolyte sheet (without cracks) according to an example;

FIG. 5 illustrates charge-discharge curves of a solid-state battery according to a comparative example; and

FIG. 6 illustrates charge-discharge curves of a solid-state battery according to an example.

### DETAILED DESCRIPTION OF THE INVENTION

Hereinafter, an embodiment of the present invention will be described.

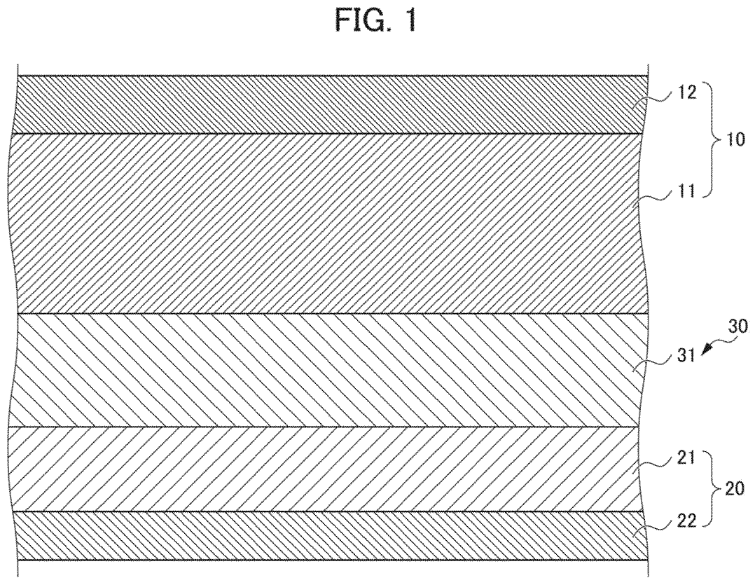

FIG. 1 is a cross section of a solid-state battery 1 according to an embodiment of the present invention. As illustrated in FIG. 1, the solid-state battery 1 is provided with a positive electrode 10, a negative electrode 20, and a solid electrolyte layer 30. The solid-state battery 1 is a laminate in which the positive electrode 10, the solid electrolyte layer 30, and the negative electrode 20 are layered, in that order. The solid-state battery 1 of the embodiment is a lithium-ion solid-state battery. Note that the solid-state battery in this specification refers to a battery that is entirely solid-state.

The positive electrode 10 includes a positive electrode layer 11 and a positive electrode current collector 12. The positive electrode layer 11 is disposed on the solid electrolyte layer 30 side. The positive electrode current collector 12 foams the surface of the solid-state battery 1 on the positive electrode 10 side.

The positive electrode layer 11 includes a positive electrode active material. The positive electrode active material used in the positive electrode layer 11 is not particularly limited, and may be any material that would function as the positive electrode of the solid-state battery 1. Note that specific examples of the positive electrode active material include, among sulfides, titanium sulfide (TiS₂), molybdenum sulfide (MoS₂), iron sulfide (FeS, FeS₂), copper sulfide (CuS), and nickel sulfide (Ni₃S₂). Also, specific examples include, among oxides, bismuth oxide (Bi₂O₃), bismuth plumbate (Bi₂Pb₂O₅), copper oxide (CuO), vanadium oxide (V₆O₁₃), lithium cobalt oxide (LiCoO₂), lithium nickel oxide (LiNiO₂), lithium manganate (LiMnO₂), Li(NiCoMn)O₂, Li(NiCoAl)O₂, and Li(NiCo)O₂. Moreover, it is also possible to use a mixture of the above.

The positive electrode current collector 12 functions to collect current for the positive electrode layer 11. The positive electrode current collector 12 is a foil-like member containing a conductive electrode material. The electrode material used in the positive electrode current collector 12 is not particularly limited insofar as the material is conductive, and examples thereof include vanadium, aluminum, stainless steel, gold, platinum, manganese, iron, and titanium. Among these, aluminum is particularly preferable. The shape and thickness of the positive electrode current collector 12 are not particularly limited as long as current for the positive electrode layer 11 can be collected.

The negative electrode 20 includes a negative electrode layer 21 and a negative electrode current collector 22. The negative electrode layer 21 is disposed on the solid electrolyte layer 30 side. The negative electrode current collector 22 forms the surface of the solid-state battery 1 on the negative electrode 20 side.

The negative electrode layer 21 includes a negative electrode active material. The negative electrode active material used in the negative electrode layer 21 is not particularly limited, and may be any material that would function as the negative electrode of the solid-state battery 1, but the inclusion of at least one selected from a Li-based material and a Si-based material is preferable from the standpoint of obtaining favorable ion conductivity. Note that specific examples of the negative electrode active material include carbon materials, specifically, artificial graphite, graphite carbon fiber, resin-fired carbon, vapor-deposited pyrolytic carbon, coke, mesocarbon microbeads (MCMB), furfuryl alcohol resin-fired carbon, polyacene, pitch-based carbon fiber, vapor-deposited carbon fiber, natural graphite, and non-graphitizable carbon. A mixture of the above is also possible. Other examples include metals themselves, such as lithium metal, indium metal, aluminum metal, or silicon metal, or alloys combining these metals with other elements or compounds.

The negative electrode current collector 22 functions to collect current for the negative electrode layer 21. The negative electrode current collector 22 is a foil-like member containing a conductive electrode material. The electrode material used in the negative electrode current collector 22 is not particularly limited insofar as the material is conductive, and examples thereof include vanadium, stainless steel, manganese, iron, titanium, copper, nickel, cobalt, and zinc. Among these, copper and nickel are particularly preferable for their excellent conductivity and excellent current collection properties. The shape and thickness of the negative electrode current collector 22 are not particularly limited as long as current for the negative electrode layer 21 can be collected.

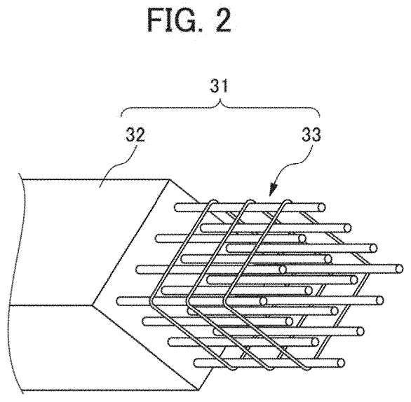

The solid electrolyte layer 30 includes a solid electrolyte sheet 31. The solid electrolyte sheet 31 is a sheet-like, porous base material filled with a solid electrolyte. As illustrated in FIG. 2, the solid electrolyte sheet 31 includes a solid electrolyte 32, a porous base material 33 placed in the solid electrolyte 32, and a binder, not illustrated, that is mixed into the solid electrolyte 32. The solid electrolyte 32 includes portions famed by solid electrolyte materials being bound together by the binder. The solid electrolyte 32 may also have a portion that does not include the binder. The solid electrolyte layer 30 including the solid electrolyte sheet 31 is disposed between the positive electrode 10 and the negative electrode 20.

The base material 33 is a porous sheet with voids. The base material 33 preferably is a woven or non-woven fabric formed into a sheet shape. A woven or non-woven fabric has a suitable porosity and thickness, and is easily filled with the solid electrolyte 32. The material of the base material 33 is not particularly limited, and may be any material with which a self-supporting sheet can be formed. Examples include polyethylene terephthalate, nylon, aramid, Al₂O₃, and glass. Additionally, the base material 33 preferably is formed from heat-resistant fiber. By forming the base material 33 from heat-resistant fiber, shorting can be suppressed in the manufacturing process and the like of the solid-state battery 1, even if pressing is performed at high temperatures exceeding 200° C., for example. Moreover, the solid electrolyte 32 can be sintered with a high-temperature press, and as a result, the interface resistance can be lowered and the output of the battery can be improved.

Note that, among heat-resistant fibers, the base material 33 forming the solid electrolyte sheet 31 of the present invention preferably is aramid fiber or Al₂O₃ fiber. In the case of aramid fiber or Al₂O₃ fiber, heat-induced defamation of the fiber is reduced.

The solid electrolyte material used in the solid electrolyte sheet 31 may be any material that allows for lithium ion conduction between the positive electrode 10 and the negative electrode 20, and is not particularly limited. Examples include oxide electrolytes and sulfide electrolytes. Note that the same material as the sulfide electrolyte used in the positive electrode layer 11 can be used as the solid electrolyte material used in the solid electrolyte sheet 31. The solid electrolyte material fills the voids in the base material 33.

The solid electrolyte 32 of the solid electrolyte sheet 31 preferably includes a lithium element. Among these, a material containing at least lithium sulfide as a first component and synthesized from one or more compounds selected from the group consisting of silicon sulfide, phosphorus sulfide, and boron sulfide as a second component is preferable, with Li₂S—P₂S₅ being particularly preferable in view of lithium ion conductivity.

In the case in which the solid electrolyte 32 of the solid electrolyte sheet 31 is a sulfide electrolyte, a sulfide such as SiS₂, GeS₂, or B₂S₃ additionally may be included. Moreover, Li₃PO₄, halogen, a halogen compound, or the like may also be added to the solid electrolyte 32, as appropriate.

In the case in which the solid electrolyte 32 of the solid electrolyte sheet 31 is a lithium ion conductor famed from an inorganic compound, examples include Li₃N, LISICON, LIPON (Li_{3+y}PO₄₋ₓNₓ) Thio-LISICON (Li_{3.25}Ge_{0.25}P_{0.75}S₄) Li₂O—Al₂O₃—TiO₂—P₂O₅ (LATP).

The solid electrolyte 32 of the solid electrolyte sheet 31 may have an amorphous, vitreous, crystalline (crystallized glass), or other structure. In the case in which the solid electrolyte 32 is a sulfide solid electrolyte famed from Li₂S—P₂S₅, the lithium ion conductivity of an amorphous body is approximately 10⁻⁴ Scm⁻¹. On the other hand, the lithium ion conductivity in the case of a crystalline body is approximately 10⁻³ Scm⁻¹.

The solid electrolyte 32 of the solid electrolyte sheet 31 preferably includes at least one selected from phosphorus and sulfur. With this configuration, the ion conductivity of the obtained solid-state battery 1 can be improved.

The binder according to the embodiment can adhere to the surface of the base material 33 and to the solid electrolyte material. A binder containing, for example, an adhesive resin exhibiting adhesive properties is preferable. Examples of the solid electrolyte material include (meth)acrylic thermoplastic resin, silicone resin, urethane resin, nitrile resin, polyester resin, cellulose resin, styrene resin, styrene butadiene resin, vinyl acetate resin, fluoroethylene resin, polyvinyl ether, and rubber. Note that “(meth)acrylic” is used as a collective term referring to acrylic and methacrylic.

When 100% by mass is taken to mean the entirety of the solid electrolyte sheet 31, the binder content included in the solid electrolyte sheet 31 according to the embodiment is equal to or higher than 10% by mass.

### Example

A solid electrolyte sheet according to an example based on the above embodiment was prepared. A solid electrolyte sheet according to a comparative example was also prepared, having the same structure but a different binder content compared to the solid electrolyte sheet according to the example.

Table 1 below indicates the solid electrolyte sheets according to the comparative example and the example. In Table 1, the binder content is the binder content (% by mass) when 100% by mass is taken to mean the entirety of the solid electrolyte sheet. Accordingly, the example has a binder content of 10% by mass and thus is a product of the present invention, whereas the comparative example having a binder content of 3% by mass is outside the present invention. The binder volume ratio is the volume ratio (%) of the binder with respect to the volume of the entirety of the solid electrolyte sheet. For the base material, a woven fabric was used in both the example and the comparative example. The particle size of the solid electrolyte is D50 (median diameter).

TABLE 1

| | Particle size of | | Binder | | |
|---|---|---|---|---|---|
| | solid | Binder | volume | Base | Thick- |
| | electrolyte (D50) | content | ratio | material | ness |
| Comparative | 0.7 (μm) | 3 (% by | 6.7(%) | Woven | 40 (μm) |
| Example | | mass) | | fabric | |
| Example | 0.7 (μm) | 10 (% by | 23.7(%) | Woven | 30 (μm) |
| | | mass) | | fabric | |

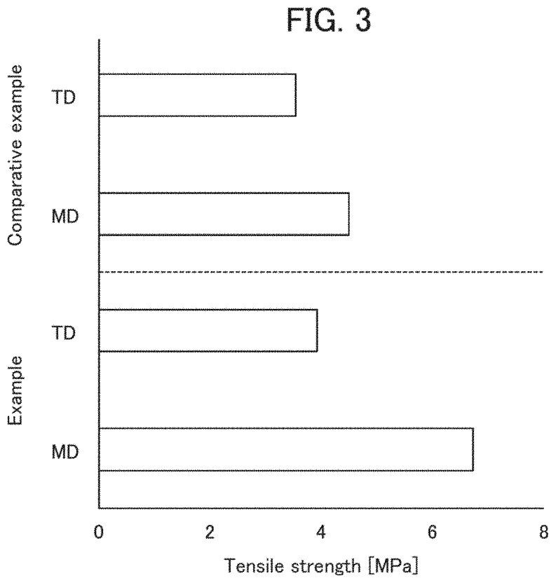

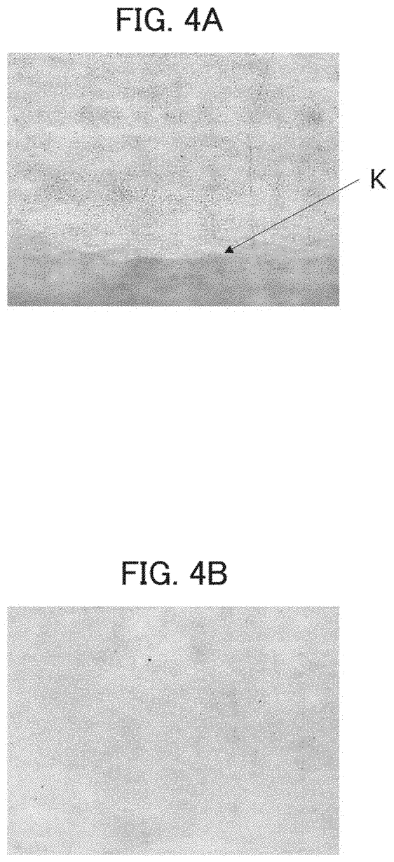

For the solid electrolyte sheet of the comparative example and the example, the tensile strength (MPa) was measured in each of TD and MD. Note that MD refers to the machine direction (longitudinal direction), that is, the direction of formation of the woven fabric serving as the base material, while TD refers to the transverse direction orthogonal to the machine direction. The results are illustrated in FIG. 3. Additionally, after roll-pressing the solid electrolyte sheets of the comparative example and the example at a pressure of 900 MPa, the surfaces were observed to check for cracks. The results are illustrated in FIG. 4A (comparative example) and FIG. 4B (example).

As illustrated in FIG. 3, compared to the solid electrolyte sheet of the comparative example, the solid electrolyte sheet of the example has a higher tensile strength in both MD and TD. This difference is due to the binder content, demonstrating that the inclusion of 10% by mass of the binder results in improved strength of the solid electrolyte sheet. The solid electrolyte sheet of the comparative example with relatively lower strength in this way exhibited cracks (denoted by the arrow K), as illustrated in FIG. 4A. In contrast, the solid electrolyte sheet of the example did not exhibit cracks, as illustrated in FIG. 4B, confirming improved strength. Thus, the solid electrolyte sheet of the example can be made thinner than the comparative example. Moreover, the thinner sheet can be made flexible enough to bend, and can also follow the expansion and contraction of Li metal and the like.

Next, the prepared solid electrolyte sheets of the example and the comparative example were each used to prepare respective solid-state batteries. The solid-state batteries were prepared by laminating sheet-like negative electrode—solid electrolyte sheet —sheet-like positive electrode, and pressurizing the laminate in a roll press machine. The roll press was set to a pressure of 700 MPa for the comparative example and 900 MPa for the example. The roll press was set to a pressure of 700 MPa for the comparative example because roll-pressing at 900 MPa caused shorting to occur and resulted in a non-functional battery, thus necessitating a lowering of the pressure.

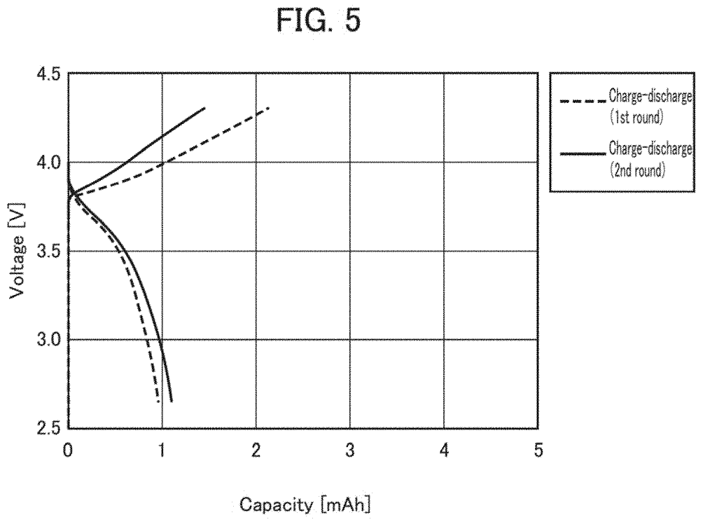

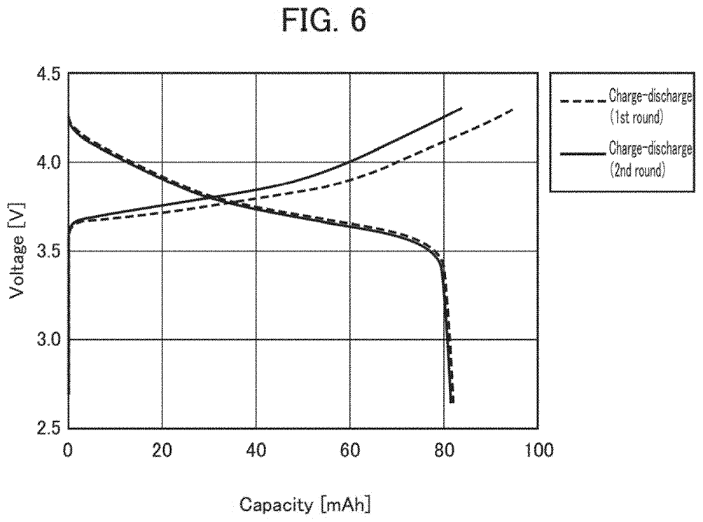

The prepared solid-state batteries of the example and the comparative example were subjected to two rounds of a process of charging to 4.3 V at a current density of 0.1 C and then discharging to 2.6 V at a current density of 0.1 C in a 25° C. environment. The charge-discharge curves of the comparative example are illustrated in FIG. 5, and the charge-discharge curves of the example are illustrated in FIG. 6.

As FIGS. 5 and 6 demonstrate, the charge-discharge capacity is much lower in the comparative example compared to the example, and the example shows favorable charge-discharge characteristics. Moreover, with regard to the charge-discharge efficiency in the second round, the solid-state battery of the comparative example shows poor charge-discharge efficiency and inadequate discharge capacity. In contrast, the solid-state battery of the example has a charge-discharge efficiency approximately 25% higher than the comparative example, showing that the charge-discharge efficiency and the discharge capacity are improved by the pressing at high load, and exhibiting sufficient battery performance.

Next, after performing the discharge capacity measurement as above, the initial resistance value of the direct-current resistance at 0.5 C was measured for the solid-state batteries of the comparative example and the example. Measurements were taken in a 25° C. environment at 50% SOC and at energization times of 0.1 s, 1 s, and 10 s, and the initial resistance was measured for each energization time. The results confirm that the initial resistance value of the example was lowered to approximately 1/15 of the comparative example.

According to the embodiment described above, the following effects are exhibited.

The solid electrolyte sheet 31 according to the embodiment is provided with the porous base material 33, the solid electrolyte material filling voids in the base material 33, and the binder adhering to the base material 33, wherein when 100% by mass is taken to mean the entirety of the solid electrolyte sheet 31, the binder content is equal to or higher than 10% by mass.

With this arrangement, the solid electrolyte sheet 31 according to the embodiment has high strength that allows for a thinner sheet. The strength improvement suppresses cracks, and as a result, yield is improved and less material is wasted, contributing to the reduction of environmental destruction. Moreover, the suppression of cracks in the solid electrolyte sheet 31 leads to improved lithium ion conductivity, and as a result, an improvement in energy efficiency is attained.

The solid-state battery 1 according to the embodiment is provided with the positive electrode layer 11 including the positive electrode active material, the negative electrode layer 21 including the negative electrode active material, and the solid electrolyte layer 30 located between the positive electrode layer 11 and the negative electrode layer 21, wherein the solid electrolyte layer 30 includes the solid electrolyte sheet 31, and the negative electrode layer 21 includes, as the negative electrode active material, at least one selected from a Li-based material and a Si-based material. With this arrangement, favorable ion conductivity is obtained.

The foregoing describes a specific embodiment of the present invention, but the present invention is not limited to the above embodiment, variations, improvements, or the like are also included in the scope of the present invention insofar as the objective of the present invention can be achieved.

### EXPLANATION OF REFERENCE NUMERALS

1 solid-state battery
11 positive electrode layer
21 negative electrode layer
30 solid electrolyte layer
31 solid electrolyte sheet
33 base material

What is claimed is:

1. A solid electrolyte sheet comprising:
a porous base material;
a solid electrolyte material filling voids in the base material; and
a binder adhering to the base material, wherein when 100% by mass is taken to mean an entirety of the solid electrolyte sheet, content of the binder is equal to or higher than 10% by mass.

2. A solid-state battery comprising:
a positive electrode layer including a positive electrode active material;
a negative electrode layer including a negative electrode active material; and
a solid electrolyte layer located between the positive electrode layer and the negative electrode layer, wherein
the solid electrolyte layer includes the solid electrolyte sheet according to claim 1, and
the negative electrode layer includes, as the negative electrode active material, at least one selected from a Li-based material and a Si-based material.
